(19) United States
(12) Patent Application Publication
(10) Pub. No.: US 2009/0136614 A1
(43) Pub. Date: May 28, 2009

(54) Hot Runner Manifold Plug

(75) Inventors: Keith CARLTON, Caledon (CA); Martin BAUMANN, Burlington, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/944,651

(22) Filed: Nov. 26, 2007

(51) Int. Cl. B29C 45/30

(52) U.S. Cl. 425/567

(57) ABSTRACT

A manifold plug for a hot runner manifold for an injection molding system has a generally circular shaped outer surface in which is disposed a channel extending along at least an arc of the generally circular shaped outer surface of the manifold plug. The manifold plug is configured for insertion into a generally circular shaped opening in the hot runner manifold and serves to fluidly interconnect at least first and second hot runner passageways which are otherwise unconnected and which terminate in the generally circular opening in the hot runner manifold. The channel in the generally circular shaped outer surface of the manifold plug is configured for fluidly connecting at least first and second unconnected resin passageways. The channel in the generally circular shaped outer surface of the manifold plug is configured for at least partially forming a resin passageway having a size and shape to allow for generally the same volume of resin to flow in the resin passageway as a pre-determined volume of resin carried by the hot runner manifold.

### TECHNICAL FIELD

The present invention relates to injection molding equipment and more particularly, relates to a plug insert for a hot runner manifold for injection molding of thermally sensitive resins.

### BACKGROUND INFORMATION

Externally heated hot runner manifolds with internally drilled passages are typically used with injection molding machines when injecting resins into multi-cavity molds. Different types of resins from different resin sources may be mixed together in the manifolds prior to being inserted in the mold. Moreover, plastic molding requires the distribution of the resin to multiple locations, thus necessitating multiple passages or runners within the manifold.

Plastic resin injected into a manifold must flow against the manifold runner walls or passages. One problem that exists is that the thermal properties of the resin can be affected as the resin flows through the manifold. The amount of time the resin spends in the mold and the temperature of the resin in the mold will have an effect on the properties of the finished product.

It is well known that as resin is forced through the manifold system, a temperature differential develops in the resin between the temperature of the resin in the center of the channel and the temperature of the resin along the wall of the manifold due to shear within the resin itself. Some prior art manifold plugs have been designed to deal with this temperature differential caused by shear layers within the melt stream. One such prior art plug is shown in U.S. Pat. No. 5,683,731 assigned to the assignee of the present invention. Such manifold plugs are designed to serve a very specific purpose and a very complicated to manufacture given that the channel in the manifold plug must go from the exterior of the manifold plug to receive holder resin along the manifold wall to the center of the manifold or runner to remakes the colder resin along the manifold wall with the warmer resin at the center of the manifold or runner system.

Generally, manifolds are produced which are somewhat generic or general in design having an internal runner system with two or more runner passages which intersect at one more various points within the manifold. At the points of intersection, a hole is provided into which may be inserted a specially designed manifold plug. Each specially designed manifold plug is provided with internally drilled passageways specifically designed to link selected runner passageways within the manifold based on the resin sources needed for a particular molding. The prior art manifold plugs with internal passageways are created by drilling the manifold plug. This creates undesirable sharp corners and edges within the hot runner system. It is the sharp corners and edges that typically cause problems within the manifold by creating more sheer layers within the resin distribution system.

It is well known that thermally sensitive resin is sheared and thus overheated when injected under pressure over sharp corners or edges found within the manifold system. Sharp corners or edges occur whenever two or more passages intersect within the hot runner manifold especially within the manifold plugs.

Accordingly, what is needed is a system and method for providing hot runner manifold plugs that avoid the sharp corners and edges normally found in internally bored hot runner manifold plugs and wherein such manifold plugs are able to generally completely turn and distribute the volume of resin found in the source manifold.

### SUMMARY

The present invention features a manifold plug for a hot runner manifold of an injection molding system. The manifold plug includes a generally circular shaped outer surface. The generally circular shaped outer surface includes a channel extending along at least an arc in the outer surface of the circular shaped manifold plug. The manifold plug is configured for insertion into a generally circular shaped opening in the hot runner manifold. The hot runner manifold includes at least first and second unconnected runner passageways. The first and second unconnected hot runner passageways provide a passageway for flowable material.

The first and second unconnected runner passageways terminate in the generally circular shaped opening in the hot runner manifold. The channel or passageway in the generally circular shaped outer surface of the manifold plug is configured for fluidly connecting at least the first and second otherwise unconnected runner passageways. The channel in the generally circular shaped outer surface of the manifold plug extends only partially through and not completely through a cross-section of the manifold plug.

The channel in the generally circular shaped outer surface of the manifold plug is sized to generally accommodate the flow of material, such as resin, in the passageways of the manifold. In one embodiment, the channel alone accommodates generally the same flow as the manifold. In another embodiment, a channel in the outer surface of the generally circular shaped manifold plug cooperates with a channel on the inner surface of the generally circular shape hole in the manifold which accommodates the manifold plug to allow for sufficient flow to matched that of the flow in the manifold.

In the preferred embodiment, the generally circular shaped opening in the hot runner manifold and at least a portion of the manifold plug include an alignment keyway, for facilitating alignment of the manifold plug in the circular shaped opening in the hot runner manifold.

The manifold plug may also include a head portion having a circumference which is greater than a circumference of the generally circular shaped outer surface of the manifold plug. The head portion is sized and configured to frictionally engage with a corresponding shoulder region located in the generally circular shaped opening of the hot runner manifold.

### BRIEF DESCRIPTION OF THE DRAWINGS

These and other features and advantages of the present invention will be better understood by reading the following detailed description, taken together with the drawings wherein:

FIG. 1 is a cross-sectional view of a hot runner manifold and hot runner manifold plug constructed in accordance with the teachings of the present invention;

FIG. 2 is a top view of a portion of a hot runner manifold into which a manifold plug may be inserted showing various resin passageways or runners within a manifold;

FIG. 3 is a cross-sectional view of a manifold plug constructed in accordance with the teachings of the present invention taken along the lines 3-3 of FIG. 2; and

FIG. 4 is a cross-sectional view of a manifold plug constructed in accordance with the teachings of the present invention taken along the lines 4-4 of FIG. 2 showing a portion of the resin passageway formed by the wall of the hole in a manifold adjacent the manifold plug.

### DETAILED DESCRIPTION OF THE PREFERRED EMBODIMENTS

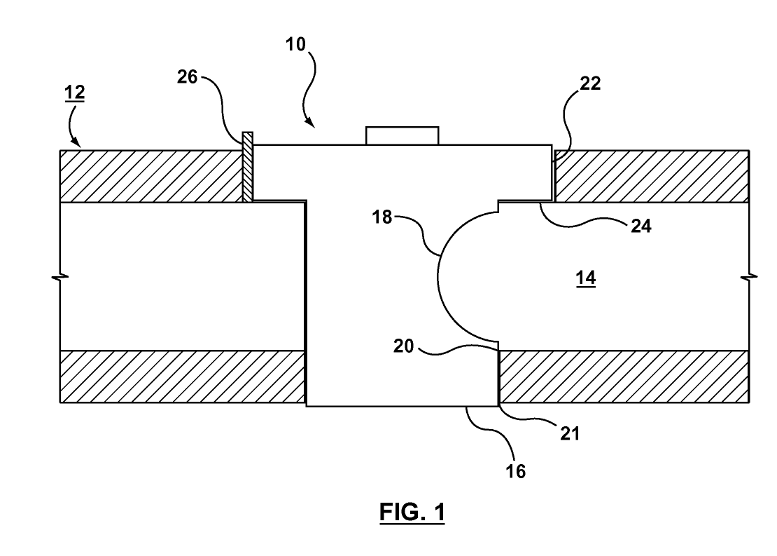

The present invention features a novel manifold plug 10, FIG. 1, for use in a hot runner manifold 12 familiar to those skilled in the art for use in an injection molding machine. As is well known in the art, hot runner manifolds 12 include one or more resin channels or passageways 14 often referred to as “runners” which terminate in the generally circular shaped opening 16 into which the manifold plug 10 is inserted and originate from some other location in the hot runner manifold 12. The runners 14 provide passageways through which can flow material such as resin utilized in the injection molding process.

A manifold plug 10 in accordance with the teachings of the present invention includes at least one channel 18 machined, milled or otherwise provided in the outer circular shaped surface 20 of the manifold plug 10. The channel 18 is located to appropriately interconnect with two or more passageways 14 located in the hot runner manifold as will be explained in greater detail below, and sized to accommodate generally the same resin flow volume as that carried by passageway 14 in the manifold plug. Channel 18 made carry this volume either alone, or in combination with a similarly shaped channel in the circular shaped sidewall 21 of the manifold 12. The channel 18 does not extend completely through the manifold plug 10 but rather, is disposed only on the outer surface 20 of the manifold plug. In this manner, the channel 18 may be milled, etched or otherwise provided in the outer surface of the manifold plug without any sharp edges or tight bends which would impact on the resin or other material flowing through the runners 14.

The manifold plug 10 includes a head portion 22 that is sized to press fit into a shoulder region 24 located in the manifold 12. In addition, the manifold 12 as well as the head portion 22 of the manifold plug may each include a keyway or other similar element 26 which facilitates and ensures proper orientation of the manifold plug within the opening 16 of the manifold 12 to guarantee that a proper flow path is established between two or more unconnected passageways 14 in the manifold which terminate in the opening 16 of the manifold.

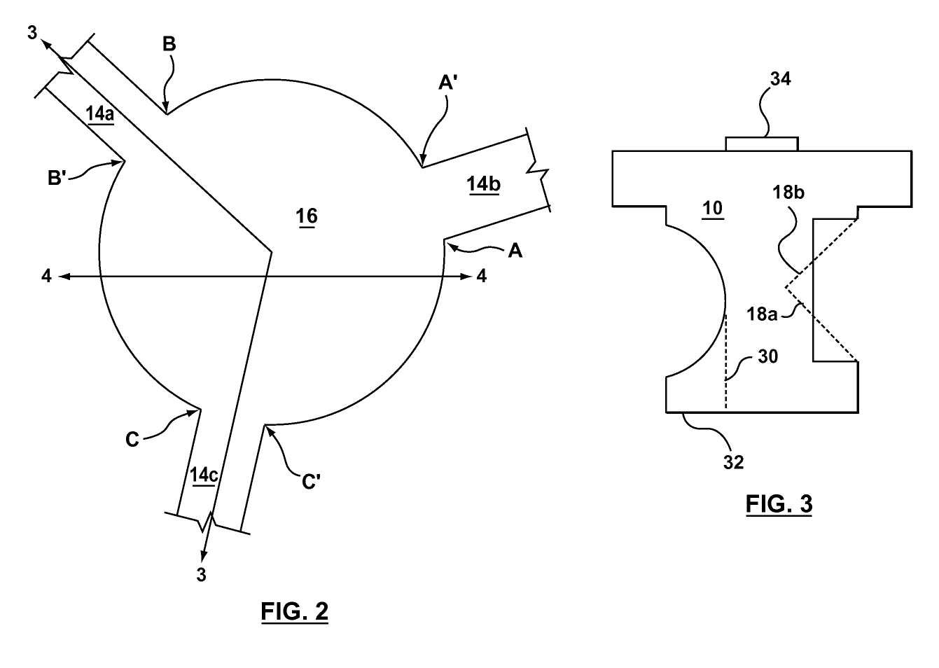

As shown in FIG. 2, the generally circular shaped opening 16 in manifold 12 typically includes one or more passageways 14 that are otherwise unconnected and which terminate in the opening 16. As is readily apparent, a manifold plug having a channel in its circular shaped outer surface may interconnect one or more passages 14 which terminate in the opening 16. For example, if it is desired to connect passageways 14a and 14b, the manifold plug 10 would have a channel 18 extending from point “B′” to point “A”. Similarly, a manifold plug configured to connect passageways 14c to 14b would include a channel 18 extending from point “C” to point “A′”. As is readily apparent, any combination of passageways may be joined in this manner. In addition, the manifold plug 10 may include a channel indicated generally by dashed line 30, FIG. 3 extending to a bottom region 32 of manifold plug 10 if it is desired to connect a passageway entering from a bottom region of the manifold plug. Moreover, the channel 18 provided in the outer surface of the manifold plug 16 may have any desired and useful shape other than a semicircular shape 18 such as, but not limited to, a “V” shape 18a and a rectangular shape 18b. Other contemplated shapes, without limitation include square, oval, octagon, etc.

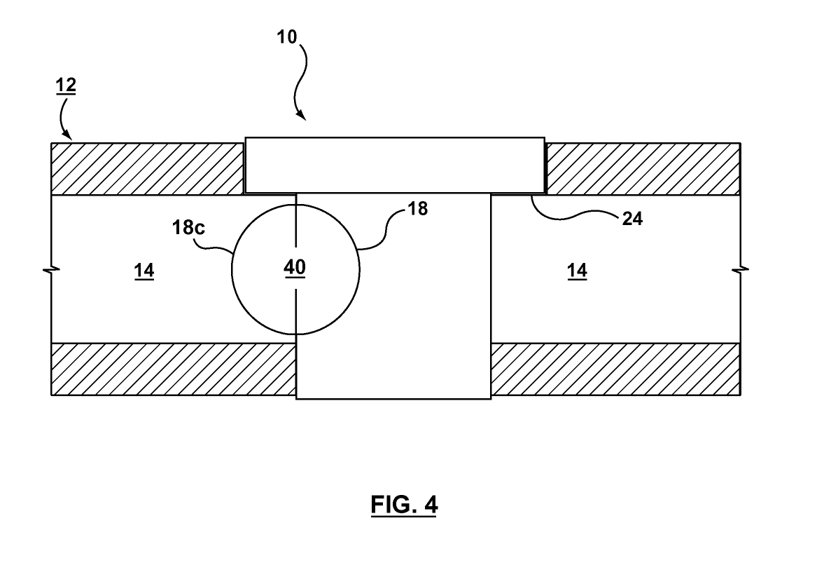

In another embodiment of the manifold plug 10, FIG. 4, in accordance with the teachings of the present invention, a channel 18 may be provided not only in the manifold plug 10 but also a channel portion 18c may be provided in the wall of the manifold 12 to provide a large enough opening 40 so as to match the flow volume which is provided by the passageway 14 in the manifold 12.

Accordingly, the present invention provides a novel manifold plug for a hot runner manifold system for use with an injection molding machine which eliminates a sharp corners and edges found in the prior art manifold plugs which are drilled through the plug to interconnect runners or passageways. Most importantly, the present invention provides a novel manifold plug that is easy to manufacture and provides a resin flow passageway channel which can carry generally the same volume of resin as can be carried in passageway 14 in the manifold plug 12. thus the present invention is not used simply to carry a small volume of resin as in the prior art, to makes resins of different temperatures but rather, all of the directional change of the entire volume of the resin flowing to the manifold is accomplished by an easy to manufacture, low cost manifold plug.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A manifold plug for a hot runner manifold of an injection molding system, said hot runner manifold configured for carrying a pre-determined volume of resin, the manifold plug comprising:
a manifold plug having a generally circular shaped outer surface, said generally circular shaped outer surface including a channel extending along at least an arc of said generally circular shaped outer surface of said manifold plug, said manifold plug configured for insertion into a generally circular shaped opening in said hot runner manifold, said hot runner manifold including at least first and second unconnected resin passageways, said first and second unconnected resin passageways providing a passageway for flowable resin and terminating in said generally circular shaped opening in said hot runner manifold, and wherein said channel in said generally circular shaped outer surface of said manifold plug is configured for fluidly connecting at least said first and second unconnected resin passageways, and further wherein said channel in said generally circular shaped outer surface of said manifold plug is configured for at least partially forming a resin passageway having a size and shape to allow for generally the same volume of resin to flow in said resin passageway as said pre-determined volume of resin carried by said hot runner manifold.

2. The manifold plug of claim 1, wherein said resin passageway in said manifold plug alone is configured for.

3. The manifold plug of claim 1, wherein said generally circular shaped opening in said hot runner manifold includes a passageway formed in at least a portion of an interior surface of said generally circular shaped opening, and where in said passageway formed in at least a portion of said interior surface of said generally circular shaped opening in said hot runner manifold and said resin passageway in said manifold plug are sized, shaped and configured to interact and together form a resin passageway allowing for generally the same volume of resin to flow in said resin passageway as said pre-determined volume of resin carried by said hot runner manifold.

4. The manifold plug of claim 1, wherein said generally circular shaped opening in said hot runner manifold and at least a portion of said manifold plug include an alignment keyway, for facilitating proper alignment of said manifold plug in said circular shaped opening in said hot runner manifold.

5. The manifold plug of claim 1, wherein said manifold plug includes a head portion having a circumference which is greater than a circumference of the generally circular shaped outer surface of said manifold plug, and wherein said head portion is sized and configured to frictionally engage with a corresponding shoulder region located in said generally circular shaped opening of said hot runner manifold.

6. The manifold plug of claim 1, wherein said channel in said generally circular shaped outer surface of said manifold plug is semicircular shaped.

7. The manifold plug of claim 6, wherein said semicircular shaped channel in said outer surface of said manifold plug extends only partially through a cross-section of said manifold plug.

8. The manifold plug of claim 1, wherein said channel in said generally circular shaped outer surface of said manifold plug is selected from the group consisting of semicircular shaped, square shaped, V shaped, and rectangular shaped.
